(19) United States
(12) Patent Application Publication
(10) Pub. No.: US 2006/0056538 A1
(43) Pub. Date: Mar. 16, 2006

(54) Apparatus and method for transmitting data using full-diversity, full-rate STBC

(75) Inventors: Seung-Hoon Nam, Seoul (KR); Chan-Soo Hwang, Yongin-si (KR); Jae-Hak Chung, Seoul (KR); Young-Ho Jung, Youngin-si (KR); Won-Il Roh, Youngin-si (KR); Chan-Byoung Chae, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/205,931

(22) Filed: Aug. 17, 2005

(30) Foreign Application Priority Data
Aug. 17, 2004 (KR) 2004-64902

(51) Int. Cl. H04L 27/36; H04B 7/06

(52) U.S. Cl. 375/298; 375/299

(57) ABSTRACT

A data transmission apparatus and method using a full-diversity, full-rate STBC are provided. In the data transmission apparatus, a serial-to-parallel converter converts an input bit stream to parallel binary vectors. A bit/symbol mapper generates modulator input symbols by combining the bits of the binary vectors. A modulator modulates the modulator input symbols to complex symbols. A transmit matrix block encoder encodes the complex symbols using a transmit matrix and transmits the coded symbols through corresponding transmit antennas.

### PRIORITY

This application claims priority under 35 U.S.C. § 119 to an application entitled “Apparatus And Method For Transmitting Data Using Full-Diversity, Full-Rate STBC” filed in the Korean Intellectual Property Office on Aug. 17, 2004 and assigned Serial No. 2004-64902, the contents of which are incorporated herein by reference.

### BACKGROUND OF THE INVENTION

1. Field of the Invention

The present invention relates generally to a wireless communication system, and in particular, to a space-time block coding (STBC) transmitter for achieving a diversity order equal to the number of transmit antennas despite the use of complex symbols.

2. Description of the Related Art

Transmit antenna diversity is being studied to improve the performance of a mobile communication system in a fading channel environment. Transmit antenna diversity is a technology of transmitting data through multiple antennas.

Transmit antenna diversity is a prominent transmission scheme for future-generation high-speed data communications because it offers a diversity gain by use of a plurality of transmit antennas. In this context, many channel coding techniques have been studied to achieve transmit antenna diversity gain.

An STBC scheme proposed by Tarokh et. al. is an extension of the Alamouti transmit antenna diversity scheme for a plurality of transmit antennas. In the case where complex signals are transmitted through two or more transmit antennas, 2N time intervals are taken to transmit N pieces of information. The resulting rate loss leads to a long process delay.

To overcome this drawback, a rotated quasi-orthogonal STBC was proposed which provides full diversity and full rate. This scheme is characterized in that the constellation of a complex signal is rotated prior to transmission and a maximum likelihood (ML) decoder requiring complex computation is adopted. The rotated quasi-orthogonal STBC scheme suffers from increased computation complexity at both a transmitter end and a receiver end.

An STBC scheme disclosed in IEEE C802.16e-04/204r1 “Enhancements of Space-Time Codes for the OFDMA PHY”, July 2004 enables simple decoding through a linear decoder. Yet, the constellation of complex signals is rotated, the transmission symbols are re-generated, and then a space-time coded matrix is created at a transmitter. This transmission complexity makes it difficult to implement the transmitter and thus the STBC is limited to four transmit antennas.

FIG. 1 is a block diagram of a conventional rotated quasi-orthogonal STBC encoder. Referring to FIG. 1, phase rotators 102-1 and 102-2 rotate two of four symbols output from a serial-to-parallel (S/P) converter 101 by e₁′ and e₂′ and a encoder 103 encodes four symbols including the rotated symbols by the following coding matrix, shown in Equation (1). That is, the transmission signal is subject to phase rotation and complex coding, prior to transmission.

$$[ \begin{matrix}{ⅇ}^{{jθ}_{1}} {x}_{1} & {x}_{2} & {x}_{3}^{*} & {ⅇ}^{- j {θ}_{1}} {x}_{4}^{*} \\ {x}_{2}^{*} & - {ⅇ}^{- j {θ}_{1}} {x}_{1}^{*} & {ⅇ}^{j {θ}_{1}} {x}_{4} & - {x}_{3} \\ {x}_{3} & {ⅇ}^{j {θ}_{1}} {x}_{4} & - {ⅇ}^{j {θ}_{1}} {x}_{1}^{*} & - {x}_{2}^{*} \\ {ⅇ}^{- j {θ}_{1}} {x}_{4}^{*} & - {x}_{3}^{*} & - {x}_{2} & {ⅇ}^{j {θ}_{1}} {x}_{1}\end{matrix} ] \qquad ( 1 )$$

At the receiver, the Maximum Likelihood (ML) decoder of the space time block coded signal can be decomposed into two independent ML decoders due to the quasi-orthogonal property. One detects symbols s₁ and S₃, and the other detects symbols S₂ and S₄, at the same time. Since an ML decoder detects the transmitted signal by comparing all possible codewords with a received vector, it requires high computational complexity.

### SUMMARY OF THE INVENTION

An object of the present invention is to substantially solve at least the above problems and/or disadvantages and to provide at least the advantages below. Accordingly, an object of the present invention is to provide an apparatus and method for achieving diversity at a symbol level by duplicating the bits of each binary vector symbol before modulation and mapping the bits to a plurality of transmission symbols.

Another object of the present invention is to provide an STBC transmitting apparatus and method which can be applied irrespective of the number of antennas, while reducing transmission complexity, and increase performance for an increased modulation order.

The above objects are achieved by providing a data transmission apparatus and method using a full-diversity, full-rate STBC.

According to one aspect of the present invention, in a transmitter, an S/P converter converts an input bit stream to parallel binary vectors. A bit/symbol mapper generates modulator input symbols by combining the bits of the binary vectors. A modulator modulates the modulator input symbols to complex symbols. A transmit matrix block encoder encodes the complex symbols using a transmit matrix and transmits the coded symbols through corresponding transmit antennas.

It is preferred that each of the modulator input symbols is a combination of bits extracted from different binary vectors for an identical time interval.

It is preferred that the modulator includes as many modulation modules as the number of the transmit antennas, where each of the modulation modules is a

$${2}^{\frac{{N}_{Tx} B}{2}}$$

quadrature amplitude modulation (QAM) modulation module, where B is the number of bits in every binary vector and N_{Tx} is the number of the transmit antennas.

Each of the modulation modules has a signal constellation having irregular distances between signal points to which modulator input symbols are mapped. Each of the modulation modules divides the bits of a modulator input symbol into two groups, and maps the first group to an output value on a real number axis in the signal constellation and the second group to an output value on an imaginary number axis in the signal constellation. The first group preferably includes upper bits being the first half of the modulator input symbol and the second group includes lower bits being the second half of the modulator input symbol.

According to another aspect of the present invention, in a signal transmission method, modulator input symbols are generated by combining the bits of parallel binary vectors, and modulated to complex symbols in a predetermined modulation scheme. The complex symbols are encoded using a transmit matrix and transmitted through corresponding transmit antennas.

### BRIEF DESCRIPTION OF THE DRAWINGS

The above and other objects, features and advantages of the present invention will become more apparent from the following detailed description when taken in conjunction with the accompanying drawings in which:

FIG. 1 is a block diagram of a conventional rotated quasi-orthogonal STBC encoder;

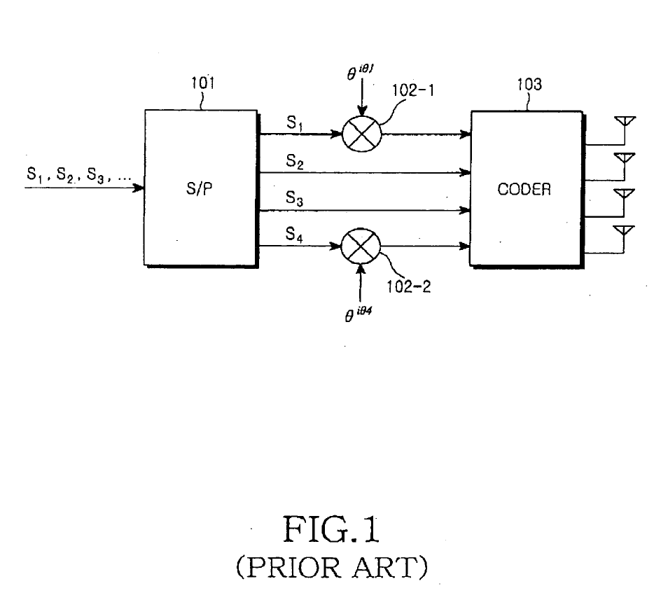

FIG. 2 is a block diagram of a transmitter with four antennas according to a preferred embodiment of the present invention;

FIG. 3A illustrates a signal constellation for a modulation module with the number of bits in a binary vector B=2 in the transmitter illustrated in FIG. 2;

FIG. 3B illustrates another signal constellation for the modulation module with B=2 in the transmitter illustrated in FIG. 2;

FIG. 4 illustrates a signal constellation for a 64QAM modulation module with B=3 in the transmitter illustrated in FIG. 2;

FIG. 5 illustrates a signal constellation for a 256QAM modulation module with B=4 in the transmitter illustrated in FIG. 2;

FIG. 6 is a block diagram of a transmitter with six transmit antennas; and

FIG. 7 is a graph illustrating the simulated performance of a transmitter using an STBC scheme according to the preferred embodiment of the present invention.

### DETAILED DESCRIPTION OF THE PREFERRED EMBODIMENT

A preferred embodiment of the present invention will be described herein below with reference to the accompanying drawings. In the following description, well-known functions or constructions are not described in detail since they would obscure the invention in unnecessary detail.

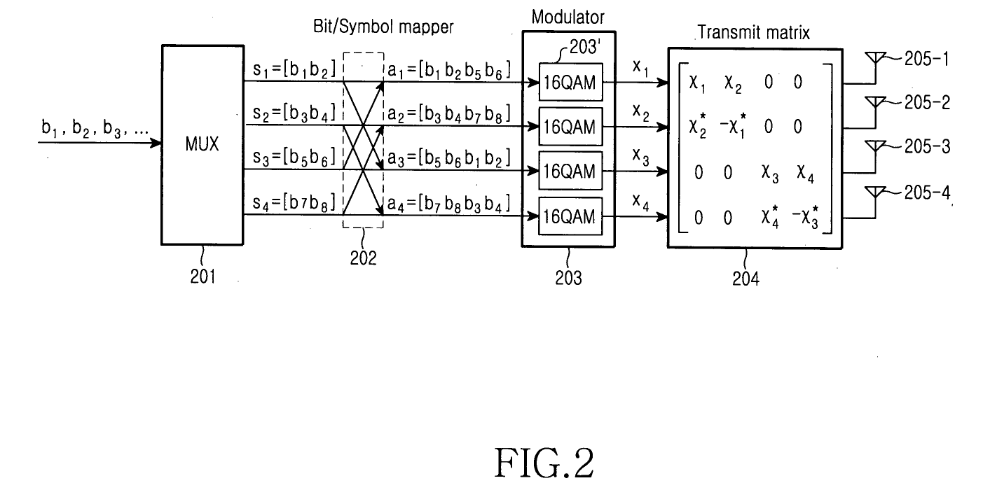

FIG. 2 is a block diagram of a transmitter according to a preferred embodiment of the present invention. Referring to FIG. 2, a multiplexer (MUX) 201 converts a serial binary bit stream into as many parallel binary vectors s₁ to S₄ as the number of transmit antennas 205-1 to 205-4. A bit/symbol mapper 202 maps the bits of every binary vector to as many other modulator input symbols as half the number of the transmit antennas 205-1 to 205-4 in order to achieve a diversity gain equal to the number of the transmit antennas. A modulator 203, which includes as many modulation modules 203′ as the number of transmit antennas 205-1 to 205-4, modulates the resulting modulator input symbols to complex symbols. Let the number of bits in every binary vector s₁ to s₄ be denoted by B and the number of the transmit antennas 205-1 to 205-4 be denoted by N_{Tx}. Then, the modulation modules 20′ are

$${2}^{\frac{{N}_{Tx} B}{2}} ,$$

and are preferably 16QAM modulation modules.

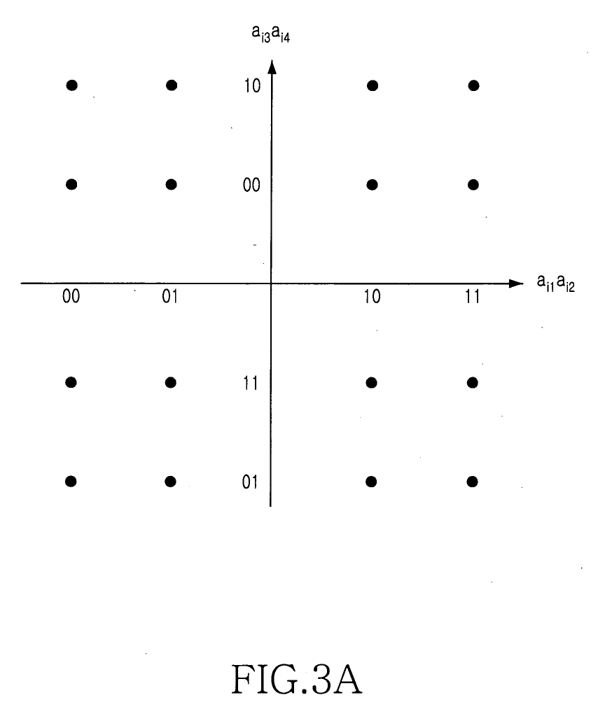

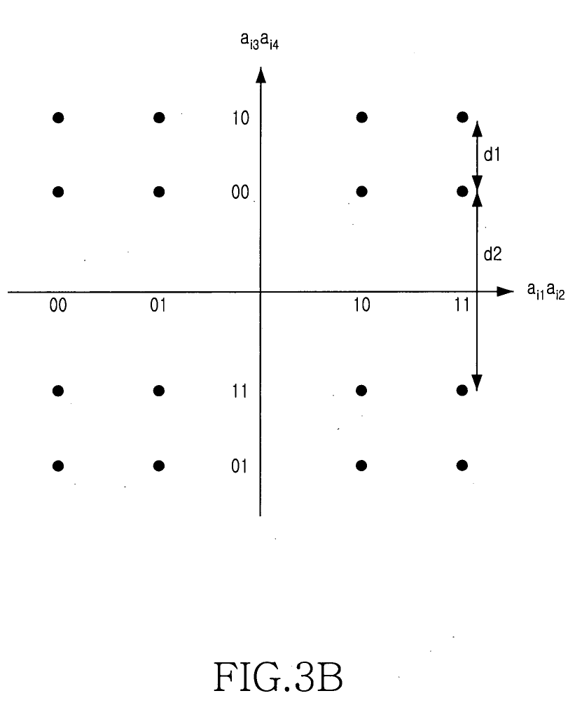

Each of the 16QAM modulation modules 203′ may have a typical signal constellation with equidistant signal points as illustrated in FIG. 3A, or an optimized signal constellation with controlled distances d₁ and d₂ between signal points to achieve an additional performance gain, as illustrated in FIG. 3B.

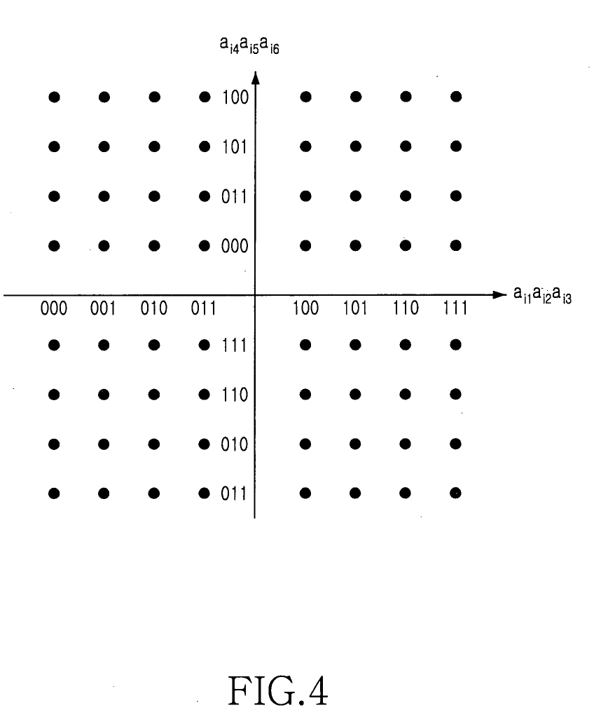

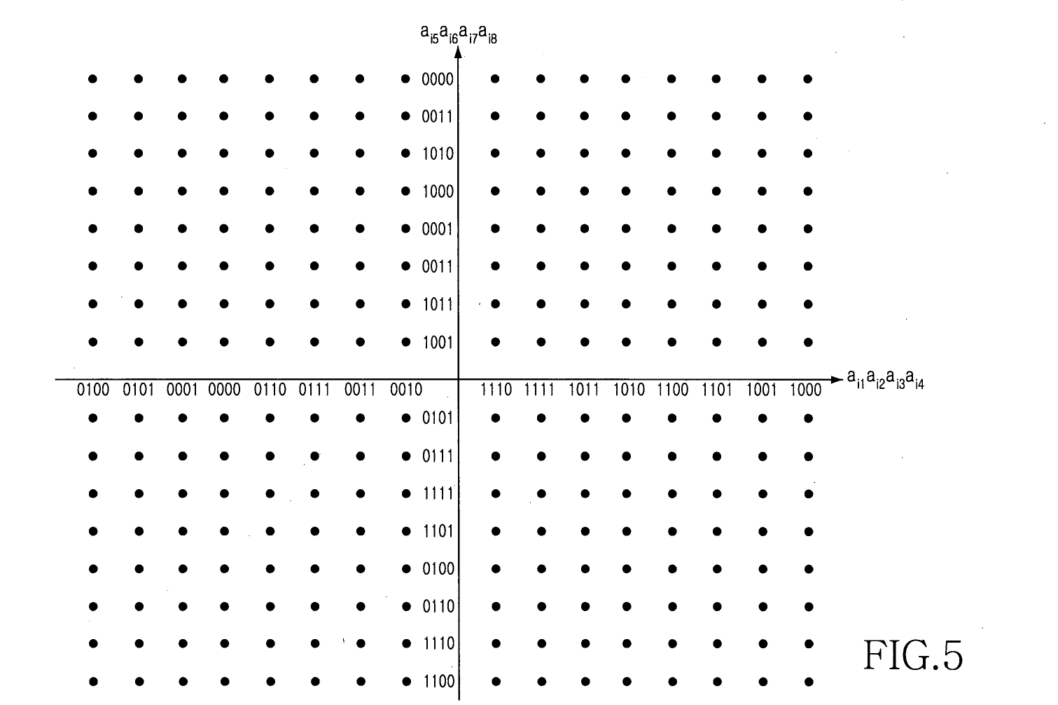

FIG. 4 illustrates a signal constellation for a 64QAM modulation module with B=3 and FIG. 5 illustrates a signal constellation for a 256QAM modulation module.

Referring to FIG. 4 and 5, an output value is determined according to the combination of the first half bits of an input symbol on a real number axis, whereas an output value is determined according to the combination of the last half bits of the input symbol on an imaginary number axis. Compared to typical QAM modulation, mapping between input bits to an output level is performed independently on the real number axis and the imaginary number axis. Therefore, the transmission reliability of bits varies depending on the position of the bits in a modulator input symbol.

Referring to FIG. 2 again, a transmit matrix block 204 transmits the modulation symbols x₁ to x₄ from the modulator 203 by a transmit matrix. The rows represent time intervals and the columns represent the respective transmit antennas 205-1 to 205-4 in the transmit matrix. Therefore, the first transmit antenna 205-1 transmits the symbol X₂* at the second time interval. In an Orthogonal Frequency Division Multiplexing (OFDM) system, the transmit matrix can be extended directly to a space-time frequency code. In this case, the rows represent subchannels or time-subchannel combinations.

Various transmit matrices are available as follows in Equations (2) through (5)

$$\begin{matrix}[ \begin{matrix}{x}_{1} & {x}_{2} & 0 & 0 \\ {x}_{2}^{*} & - {x}_{1}^{*} & 0 & 0 \\ 0 & 0 & {x}_{3} & {x}_{4} \\ 0 & 0 & {x}_{4}^{*} & - {x}_{3}^{*}\end{matrix} ] & ( 2 ) \\ [ \begin{matrix}0 & 0 & {x}_{1} & {x}_{2} \\ 0 & 0 & {x}_{2}^{*} & - {x}_{1}^{*} \\ {x}_{3} & {x}_{4} & 0 & 0 \\ {x}_{4}^{*} & - {x}_{3}^{*} & 0 & 0\end{matrix} ] & ( 3 ) \\ [ \begin{matrix}0 & 0 & {x}_{1} & {x}_{2} \\ {x}_{3} & {x}_{4} & 0 & 0 \\ 0 & 0 & {x}_{2}^{*} & - {x}_{1}^{*} \\ {x}_{4}^{*} & - {x}_{3}^{*} & 0 & 0\end{matrix} ] & ( 4 ) \\ [ \begin{matrix}0 & {x}_{1} & 0 & {x}_{2} \\ 0 & {x}_{2}^{*} & 0 & - {x}_{1}^{*} \\ {x}_{3} & 0 & {x}_{4} & 0 \\ {x}_{4}^{*} & 0 & - {x}_{3}^{*} & 0\end{matrix} ] & ( 5 )\end{matrix}$$

For three transmit antennas, the above transmit matrices are modified to have only the first three columns and data is transmitted in the same manner as in the case of using four transmit antennas.

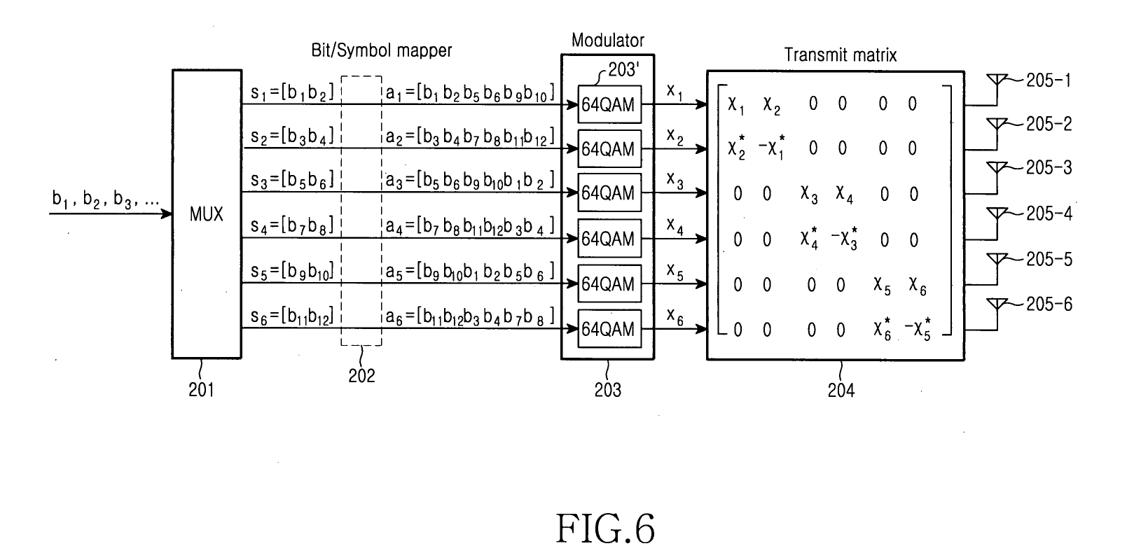

FIG. 6 is a block diagram of a transmitter with six transmit antennas. In the above-described manner, a transmitter with seven or more transmit antennas can be configured.

Referring to FIG. 6, each modulator input symbol includes 6/2=3 transmit binary vectors. An odd-numbered symbol has a combination of odd-numbered binary vectors, and an even-numbered symbol has a combination of even-numbered binary vectors. Each binary vector is positioned in all three possible modulator input symbols. Similarly to the case of four transmit antennas, many transmit matrices are available for six transmit antennas. When five transmit antennas are used, the last column is eliminated from the transmit matrix for six transmit antennas in the manner that a transmit matrix for three transmit antennas is created by eliminating the last column from that for four transmit antennas.

Meanwhile, the receiver calculates a soft bit metric for channel decoder input to decode a received signal. In the present invention, the soft bit metric is calculated as a log-likelihood ratio (LLR). Assuming a quasi-static channel and one receive antenna, the received signal is expressed as Equation (6):

$$[ \begin{matrix}{y}_{1} \\ {y}_{2} \\ {y}_{3} \\ {y}_{4}\end{matrix} ] = [ \begin{matrix}{x}_{1} & {x}_{2} & 0 & 0 \\ {x}_{2}^{*} & - {x}_{1}^{*} & 0 & 0 \\ 0 & 0 & {x}_{3} & {x}_{4} \\ 0 & 0 & {x}_{4}^{*} & {x}_{3}^{*}\end{matrix} ] [ \begin{matrix}{h}_{1} \\ {h}_{2} \\ {h}_{3} \\ {h}_{4}\end{matrix} ] + N \qquad ( 6 )$$

where yᵢ denotes a signal received at an i^{th} symbol time and hⱼ denotes the channel response between a j^{th} transmit antenna and the receive antenna. A transmission symbol xᵢ is estimated by Equation (7):

$$( \begin{matrix}\hat{{x}_{1}} \\ {\hat{x}}_{2} \\ {\hat{x}}_{3} \\ {\hat{x}}_{4}\end{matrix} ) = ( \begin{matrix}{α}^{- 1} & 0 & 0 & 0 \\ 0 & {α}^{- 1} & 0 & 0 \\ 0 & 0 & {β}^{- 1} & 0 \\ 0 & 0 & 0 & {β}^{- 1}\end{matrix} ) ( \begin{matrix}{h}_{1} & {h}_{2} & 0 & 0 \\ - {h}_{2}^{*} & {h}_{1}^{*} & 0 & 0 \\ 0 & 0 & {h}_{3} & {h}_{4} \\ 0 & 0 & - {h}_{4}^{*} & - {h}_{3}^{*}\end{matrix} ) ( \begin{matrix}{y}_{1} \\ {y}_{2}^{*} \\ {y}_{3} \\ {y}_{4}^{*}\end{matrix} ) \qquad ( 7 )$$

where α=|h₁|²+|h₂|² and β=|h₃|²+|h₄|².

The LLR of a b^{th} bit in a transmission symbol x₁, LLRx_{1b} is computed by the following Equation (8), and the LLRs of the other symbols are obtained in the same manner.

$${LLR}_{{x}_{1 b}} = log \frac{P ( {x}_{1 b} = 1 \vert {y}_{1}^{1} , {y}_{1}^{2} )}{P ( {x}_{1 b} = 0 \vert {y}_{1}^{1} , {y}_{1}^{2} )} \\ = log \frac{{\sum }_{{{s}^{\hat{\_}}}_{1} ∈ {S}_{1}^{b} ( 1 ) , {{s}^{\hat{\_}}}_{3} = f ( {{s}^{\hat{\_}}}_{1} )} P ( {y}_{1}^{1} , {y}_{1}^{2} \vert {{s}^{\hat{\_}}}_{1} ) P ( {{s}^{\hat{\_}}}_{1} )}{{\sum }_{{{s}^{\hat{\_}}}_{1} ∈ {S}_{1}^{b} ( 0 ) , {{s}^{\hat{\_}}}_{3} = f ( {{s}^{\hat{\_}}}_{1} )} P ( {y}_{1}^{1} , {y}_{1}^{2} \vert {{s}^{\hat{\_}}}_{1} ) P ( {{s}^{\hat{\_}}}_{1} )} \\ = log \frac{{\sum }_{{{s}^{\hat{\_}}}_{1} ∈ {S}_{1}^{b} ( 1 ) , {{s}^{\hat{\_}}}_{3} = f ( {{s}^{\hat{\_}}}_{1} )} P ( {y}_{1}^{1} \vert {{s}^{\hat{\_}}}_{1} ) P ( {y}_{1}^{2} \vert {{s}^{\hat{\_}}}_{3} )}{{\sum }_{{{s}^{\hat{\_}}}_{1} ∈ {S}_{1}^{b} ( 0 ) , {{s}^{\hat{\_}}}_{3} = f ( {{s}^{\hat{\_}}}_{1} )} P ( {y}_{1}^{1} \vert {{s}^{\hat{\_}}}_{1} ) P ( {y}_{1}^{2} \text{\textbar} {{s}^{\hat{\_}}}_{3} )} \\ ≅ log \frac{{max}_{{{s}^{\hat{\_}}}_{1} ∈ {S}_{1}^{b} ( 1 ) , {{s}^{\hat{\_}}}_{3} = f ( {{s}^{\hat{\_}}}_{1} )} P ( {y}_{1}^{1} \vert {{s}^{\hat{\_}}}_{1} ) P ( {y}_{1}^{2} \vert {{s}^{\hat{\_}}}_{3} )}{{max}_{{{s}^{\hat{\_}}}_{1} ∈ {S}_{1}^{b} ( 0 ) , {{s}^{\hat{\_}}}_{3} = f ( {{s}^{\hat{\_}}}_{1} )} P ( {y}_{1}^{1} \vert {{s}^{\hat{\_}}}_{1} ) P ( {y}_{1}^{2} \text{\textbar} {{s}^{\hat{\_}}}_{3} )} \\ = {min}_{{{s}^{\hat{\_}}}_{1} ∈ {S}_{1}^{b} ( 0 ) , {{s}^{\hat{\_}}}_{3} = f ( {{s}^{\hat{\_}}}_{1} )} ( \frac{α {\vert {z}_{1} - {{s}^{\hat{\_}}}_{1} \vert}^{2} + β {\vert {z}_{3} - {{s}^{\hat{\_}}}_{3} \vert}^{2}}{2 {σ}^{2}} ) - {min}_{{{s}^{\hat{\_}}}_{1} ∈ {S}_{1}^{b} ( 1 ) , {{s}^{\hat{\_}}}_{3} = f ( {{s}^{\hat{\_}}}_{1} )} ( \frac{α {\vert {z}_{1} - {{s}^{\hat{\_}}}_{1} \vert}^{2} + β {\vert {z}_{3} - {{s}^{\hat{\_}}}_{3} \vert}^{2}}{2 {σ}^{2}} ) \\ \qquad ( 8 )$$

where x_{1b} is a b^{th} binary bit applied to a bit/symbol mapper to form the complex symbol x₁ and S₁^{b}(1) is a set of constellation points each having 1 as a b^{th} bit among candidate constellation points for the transmission symbol x₁. In Equation (8), \hat{\overline{s}}₃=f(\hat{\overline{s}}₁) means that once \hat{\overline{s}}₁ is decided, \hat{\overline{s}}₃ is automatically determined by \hat{\overline{s}}₁ because the binary bits of \hat{\overline{s}}₁ have the same information as those of \hat{\overline{s}}₃, but in a different order. Since bit mapping is designed to be independent for the real number axis and the imaginary number axis in the present invention, a decoder uses candidate constellation points of a constellation size 2^{B-1}, and not 2^{2B}, in searching for a minimum Euclidean distance by the LLR equation. Therefore, decoding complexity is reduced.

For example, for B=2, the LLRs of signals transmitted by the transmitter illustrated in FIG. 2 are computed by Equation (9):

$${LLR}_{{b}_{1}} = min ( 2 α {\hat{x}}_{1 r} + β ( 6 {\hat{x}}_{3 i} + 8 ) , α ( 6 {\hat{x}}_{1 r} + 8 ) - 2 β {\hat{x}}_{3 i} ) \text{/} 0.5 {σ}_{n}^{2} - \\ min ( - 2 α {\hat{x}}_{1 r} + β ( - 6 {\hat{x}}_{3 i} + 8 ) , α ( - 6 {\hat{x}}_{1 r} + 8 ) + 2 β {\hat{x}}_{3 i} ) \text{/} 0.5 {σ}_{n}^{2} \\ {LLR}_{{b}_{2}} = min ( α ( 6 {\hat{x}}_{1 r} + 8 ) - 2 β {\hat{x}}_{3 i} , - 2 α {\hat{x}}_{1 r} + β ( - 6 {\hat{x}}_{3 i} + 8 ) ) \text{/} 0.5 {σ}_{n}^{2} - \\ min ( 2 α {\hat{x}}_{1 r} + β ( 6 {\hat{x}}_{3 i} + 8 ) , α ( - 6 {\hat{x}}_{1 r} + 8 ) + 2 β {\hat{x}}_{3 i} ) \text{/} 0.5 {σ}_{n}^{2} \\ {LLR}_{{b}_{3}} = min ( 2 α {\hat{x}}_{2 r} + β ( 6 {\hat{x}}_{4 i} + 8 ) , α ( 6 {\hat{x}}_{2 r} + 8 ) - 2 β {\hat{x}}_{4 i} ) \text{/} 0.5 {σ}_{n}^{2} - \\ min ( - 2 α {\hat{x}}_{2 r} + β ( - 6 {\hat{x}}_{4 i} + 8 ) , α ( - 6 {\hat{x}}_{2 r} + 8 ) + 2 β {\hat{x}}_{4 i} ) \text{/} 0.5 {σ}_{n}^{2} \\ {LLR}_{{b}_{4}} = min ( α ( 6 {\hat{x}}_{2 r} + 8 ) - 2 β {\hat{x}}_{4 i} , - 2 α {\hat{x}}_{2 r} + β ( - 6 {\hat{x}}_{4 i} + 8 ) ) \text{/} 0.5 {σ}_{n}^{2} - \\ min ( 2 α {\hat{x}}_{2 r} + β ( 6 {\hat{x}}_{4 i} + 8 ) , α ( - 6 {\hat{x}}_{2 r} + 8 ) + 2 β {\hat{x}}_{4 i} ) \text{/} 0.5 {σ}_{n}^{2} \\ {LLR}_{{b}_{5}} = min ( 2 β {\hat{x}}_{3 r} + α ( 6 {\hat{x}}_{1 i} + 8 ) , β ( 6 {\hat{x}}_{3 r} + 8 ) - 2 α {\hat{x}}_{1 i} ) \text{/} 0.5 {σ}_{n}^{2} - \\ min ( - 2 β {\hat{x}}_{3 r} + α ( - 6 {\hat{x}}_{1 i} + 8 ) , β ( - 6 {\hat{x}}_{3 r} + 8 ) + 2 α {\hat{x}}_{1 i} ) \text{/} 0.5 {σ}_{n}^{2} \\ {LLR}_{{b}_{6}} = min ( β ( 6 {\hat{x}}_{3 r} + 8 ) - 2 α {\hat{x}}_{1 i} , - 2 β {\hat{x}}_{3 r} + α ( - 6 {\hat{x}}_{1 i} + 8 ) ) \text{/} 0.5 {σ}_{n}^{2} - \\ min ( 2 β {\hat{x}}_{3 r} + α ( 6 {\hat{x}}_{1 i} + 8 ) , β ( - 6 {\hat{x}}_{3 r} + 8 ) + 2 α {\hat{x}}_{1 i} ) \text{/} 0.5 {σ}_{n}^{2} \\ {LLR}_{{b}_{7}} = min ( 2 β {\hat{x}}_{4 r} + α ( 6 {\hat{x}}_{4 i} + 8 ) , β ( 6 {\hat{x}}_{4 r} + 8 ) - 2 α {\hat{x}}_{2 i} ) \text{/} 0.5 {σ}_{n}^{2} - \\ min ( - 2 β {\hat{x}}_{4 r} + α ( - 6 {\hat{x}}_{2 i} + 8 ) , β ( - 6 {\hat{x}}_{4 r} + 8 ) + 2 α {\hat{x}}_{2 i} ) \text{/} 0.5 {σ}_{n}^{2} \\ {LLR}_{{b}_{8}} = min ( β ( 6 {\hat{x}}_{4 r} + 8 ) - 2 α {\hat{x}}_{2 i} , - 2 β {\hat{x}}_{4 r} + α ( - 6 {\hat{x}}_{2 i} + 8 ) ) \text{/} 0.5 {σ}_{n}^{2} - \\ min ( 2 β {\hat{x}}_{4 r} + α ( 6 {\hat{x}}_{2 i} + 8 ) , β ( - 6 {\hat{x}}_{4 r} + 8 ) + 2 α {\hat{x}}_{2 i} ) \text{/} 0.5 {σ}_{n}^{2} \qquad ( 9 )$$

where subscripts r and i denote the real number part and imaginary part of a complex symbol, respectively. B (=2) comparisons are required to compute the soft bit metric of each binary bit. Therefore, it is noted that receiver complexity is linearly proportional to the number of input bits in the present invention.

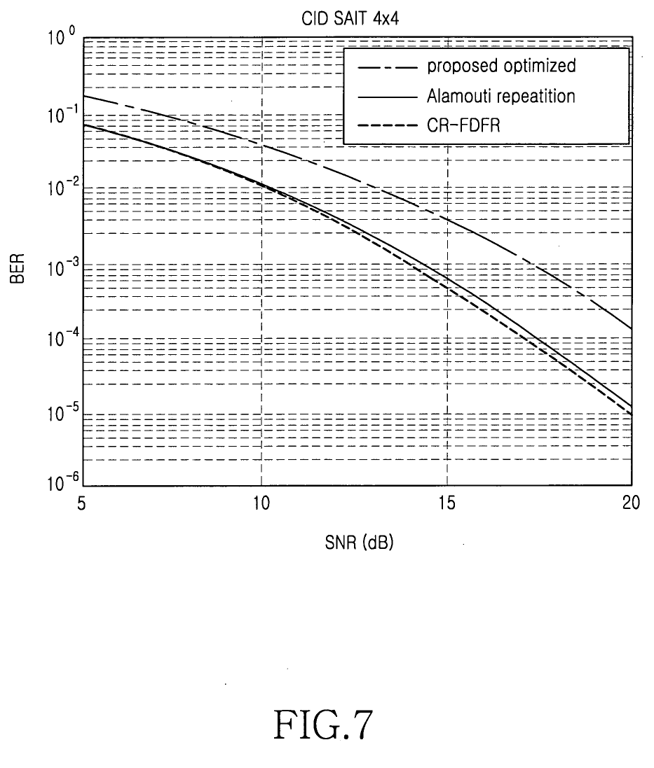

FIG. 7 is a graph illustrating the simulated performance of a transmitter using an STBC scheme according to a preferred embodiment of the present invention.

Referring to FIG. 7, the STBC scheme of the present invention performs almost the same as the rotated quasi-orthogonal STBC, and outperforms the Alamouti-repetition STBC which duplicates the conventional Alamouti STBC for four transmit antennas.

As described above, the coding method of the present invention duplicates the bits of every binary vector symbol prior to modulation and maps them to a plurality of transmission symbols. Therefore, diversity is achieved at a symbol level.

Furthermore, the coding method is applicable irrespective of the number of transmit antennas, while reducing transmission complexity. As a modulation order increases, it improves performance.

While the invention has been shown and described with reference to a certain preferred embodiment thereof, it will be understood by those skilled in the art that various changes in form and details may be made therein without departing from the spirit and scope of the invention as defined by the appended claims.

What is claimed is:

1. A transmitter comprising:
a serial-to-parallel converter for converting an input bit stream to parallel binary vectors;
a bit/symbol mapper for generating modulator input symbols by combining the bits of the binary vectors;
a modulator for modulating the modulator input symbols to complex symbols; and
a transmit matrix block encoder for encoding the complex symbols using a transmit matrix and transmitting the coded symbols through corresponding transmit antennas.

2. The transmitter of claim 1, wherein each of the modulator input symbols is a combination of bits extracted from different binary vectors for an identical time interval.

3. The transmitter of claim 1, wherein the modulator includes as many modulation modules as the number of the transmit antennas.

4. The transmitter of claim 3, wherein each of the modulation modules is a
$${2}^{\frac{{N}_{Tx} B}{2}}$$
quadrature amplitude modulation (QAM) modulation module, where B is the number of bits in every binary vector and N_{Tx} is the number of the transmit antennas.

5. The transmitter of claim 3, wherein each of the modulation modules has a signal constellation having irregular distances between signal points to which modulator input symbols are mapped.

6. The transmitter of claim 3, wherein each of the modulation modules divides the bits of a modulator input symbol into two groups, and maps a first group to an output value on a real number axis in the signal constellation and a second group to an output value on an imaginary number axis in the signal constellation.

7. The transmitter of claim 6, wherein the first group includes upper bits being a first half of the modulator input symbol and the second group includes lower bits being a second half of the modulator input symbol.

8. A signal transmission method comprising the steps of:
generating modulator input symbols by combining bits of parallel binary vectors;
modulating the modulator input symbols to complex symbols in a predetermined modulation scheme; and
encoding the complex symbols using a transmit matrix and transmitting the coded symbols through corresponding transmit antennas.

9. The signal transmission method of claim 8, wherein the generating step comprises generating each of the modulator input symbols by combining bits extracted from different binary vectors for an identical time interval.

10. The signal transmission method of claim 8, wherein the modulation scheme is
$${2}^{\frac{{N}_{Tx} B}{2}}$$
quadrature amplitude modulation (QAM) where B is the number of bits in every binary vector and N_{Tx} is the number of the transmit antennas.

11. The signal transmission method of claim 10, wherein the modulation scheme has a signal constellation having irregular distances between signal points to which modulator input symbols are mapped.

12. The signal transmission method of claim 11, wherein the modulating step comprises dividing the bits of each modulator input symbol into two groups and mapping a first group to an output value on a real number axis in the signal constellation and a second group to an output value on an imaginary number axis in the signal constellation.

13. The signal transmission method of claim 12, wherein the first group includes upper bits being a first half of the modulator input symbol and the second group includes lower bits being a second half of the modulator input symbol.

14. A decoding method in a communication system having a transmitter for converting an input bit stream to parallel binary vectors, generating modulator input symbols by combining the bits of the binary vectors, modulating the modulator input symbols to complex symbols in a predetermined modulation/demodulation scheme, encoding the complex symbols using a transmit matrix, and transmitting the coded symbols through corresponding transmit antennas, and a receiver for receiving signals from the transmit antennas on a radio channel, the method comprising the steps of:
estimating transmission symbols from the received signals;
obtaining complex symbols from the estimated transmission symbols;
obtaining modulator input symbols by demodulating the complex symbols using the same modulation/demodulation scheme as used in the transmitter;
obtaining binary vectors by demapping the modulator input symbols; and
recovering a transmission bit stream by demultiplexing the binary vectors.

15. The decoding method of claim 14, wherein the transmission symbols estimation step comprises estimating the transmission symbols using a maximum log likelihood (MLL) method.

16. The decoding method of claim 15, wherein the received signals are expressed as:
$$[ \begin{matrix}{y}_{1} \\ {y}_{2} \\ {y}_{3} \\ {y}_{4}\end{matrix} ] = [ \begin{matrix}{x}_{1} & {x}_{2} & 0 & 0 \\ {x}_{2}^{*} & - {x}_{1}^{*} & 0 & 0 \\ 0 & 0 & {x}_{3} & {x}_{4} \\ 0 & 0 & {x}_{4}^{*} & {x}_{3}^{*}\end{matrix} ] [ \begin{matrix}{h}_{1} \\ {h}_{2} \\ {h}_{3} \\ {h}_{4}\end{matrix} ] + N$$
where yᵢ denotes a signal received at an i^{th} symbol time and hⱼ denotes the channel response between a j^{th} transmit antenna and the receive antenna;
transmission symbol xᵢ is estimated by:
$$( \begin{matrix}{\hat{x}}_{1} \\ {\hat{x}}_{2} \\ {\hat{x}}_{3} \\ {\hat{x}}_{4}\end{matrix} ) = ( \begin{matrix}{α}^{- 1} & 0 & 0 & 0 \\ 0 & {α}^{- 1} & 0 & 0 \\ 0 & 0 & {β}^{- 1} & 0 \\ 0 & 0 & 0 & {β}^{- 1}\end{matrix} ) ( \begin{matrix}{h}_{1} & {h}_{2} & 0 & 0 \\ - {h}_{2}^{*} & {h}_{1}^{*} & 0 & 0 \\ 0 & 0 & {h}_{3} & {h}_{4} \\ 0 & 0 & - {h}_{4}^{*} & - {h}_{3}^{*}\end{matrix} ) ( \begin{matrix}{y}_{1} \\ {y}_{2}^{*} \\ {y}_{3} \\ {y}_{4}^{*}\end{matrix} )$$
where α=|h₁|²+|h₂|² and β=|h₃|²+|h₄|²; and
wherein an LLR of a b^{th} bit in transmission symbol x₁, LLRx_{1b} is computed by:
$$\begin{matrix}{LLR}_{{x}_{1 b}} = log \frac{P ( {x}_{1 b} = 1 \vert {y}_{1}^{1} , {y}_{1}^{2} )}{P ( {x}_{1 b} = 0 \vert {y}_{1}^{1} , {y}_{1}^{2} )} \\ = log \frac{{\sum }_{{\hat{\overline{s}}}_{1} ∈ {S}_{1}^{b} ( 1 ) , {\hat{\overline{s}}}_{3} , = f ( {\hat{\overline{s}}}_{1} )} P ( {y}_{1}^{1} , {y}_{1}^{2} \vert {\hat{\overline{s}}}_{1} ) P ( {\hat{\overline{s}}}_{1} )}{{\sum }_{{\hat{\overline{s}}}_{1} ∈ {S}_{1}^{b} ( 0 ) , {\hat{\overline{s}}}_{3} , = f ( {\hat{\overline{s}}}_{1} )} P ( {y}_{1}^{1} , {y}_{1}^{2} \vert {\hat{\overline{s}}}_{1} ) P ( {\hat{\overline{s}}}_{1} )} \\ = log \frac{{\sum }_{{\hat{\overline{s}}}_{1} ∈ {S}_{1}^{b} ( 1 ) , {\hat{\overline{s}}}_{3} , = f ( {\hat{\overline{s}}}_{1} )} P ( {y}_{1}^{1} \vert {\hat{\overline{s}}}_{1} ) P ( {y}_{1}^{2} \vert {\hat{\overline{s}}}_{3} )}{{\sum }_{{\hat{\overline{s}}}_{1} ∈ {S}_{1}^{b} ( 0 ) , {\hat{\overline{s}}}_{3} , = f ( {\hat{\overline{s}}}_{1} )} P ( {y}_{1}^{1} \vert {\hat{\overline{s}}}_{1} ) P ( {y}_{1}^{2} \vert {\hat{\overline{s}}}_{3} )} \\ ≅ log \frac{{max}_{{\hat{\overline{s}}}_{1} ∈ {S}_{1}^{b} ( 1 ) , {\hat{\overline{s}}}_{3} , = f ( {\hat{\overline{s}}}_{1} )} P ( {y}_{1}^{1} \vert {\hat{\overline{s}}}_{1} ) P ( {y}_{1}^{2} \vert {\hat{\overline{s}}}_{3} )}{{max}_{{\hat{\overline{s}}}_{1} ∈ {S}_{1}^{b} ( 0 ) , {\hat{\overline{s}}}_{3} , = f ( {\hat{\overline{s}}}_{1} )} P ( {y}_{1}^{1} \vert {\hat{\overline{s}}}_{1} ) P ( {y}_{1}^{2} \vert {\hat{\overline{s}}}_{3} )} \\ = {min}_{{\hat{\overline{s}}}_{1} ∈ {S}_{1}^{b} ( 0 ) , {\hat{\overline{s}}}_{3} , = f ( {\hat{\overline{s}}}_{1} )} ( \frac{α {\vert {z}_{1} - {\hat{\overline{s}}}_{1} \vert}^{2} + β {\vert {z}_{3} - {\hat{\overline{s}}}_{3} \vert}^{2}}{2 {σ}^{2}} ) - \\ {min}_{{\hat{\overline{s}}}_{1} ∈ {S}_{1}^{b} ( 1 ) , {\hat{\overline{s}}}_{3} , = f ( {\hat{\overline{s}}}_{1} )} ( \frac{α {\vert {z}_{1} - {\hat{\overline{s}}}_{1} \vert}^{2} + β {\vert {z}_{3} - {\hat{\overline{s}}}_{3} \vert}^{2}}{2 {σ}^{2}} )\end{matrix}$$
where x_{1b} is a b^{th} binary bit applied to a bit/symbol mapper to form the complex symbol x₁ and S₁^{b}(1) is a set of constellation points each having 1 as a b^{th} bit among candidate constellation points for the transmission symbol x₁, and \hat{\overline{s}}₃=f(\hat{\overline{s}}₁) means that once \hat{\overline{s}}₁ is decided, \hat{\overline{s}}₃ is automatically determined by \hat{\overline{s}}₁ because the binary bits of \hat{\overline{s}}₁ have the same information as those of \hat{\overline{s}}₃, but in a different order.
